(19) United States
(12) Patent Application Publication
(10) Pub. No.: US 2018/0211297 A1
(43) Pub. Date: Jul. 26, 2018

(54) Automatic Update Of A Shadow Catalog Database Based On Transactions Made Using A Catalog Database

(71) Applicant: Conduit LTD, Ness Ziona (IL)

(72) Inventors: Ronen Shilo, Ness Ziona (IL); Dror Erez, Ness Ziona (IL); Liran Mayost, Ness Ziona (IL); Danny Albocher, Ness Ziona (IL); Yair Holtzer, Ness Ziona (IL)

(73) Assignee: Conduit LTD, Ness Ziona (IL)

(21) Appl. No.: 15/416,008

(22) Filed: Jan. 26, 2017

(51) Int. Cl. G06Q 30/06; G06F 17/30

(52) U.S. Cl. CPC G06Q 30/0603; G06F 17/30002

(57) ABSTRACT

A computerized apparatus, a computer program product and a method performed by a computing device in a computerized environment, which comprises a purchase transaction processor utilizing an item catalog database. The computing device maintaining a shadow catalog database. The method comprises: in response to a transaction made by the purchase transaction processor, obtaining, by the computing device, a transaction record, wherein the transaction record comprising for each item in the transaction, an entry, wherein the entry comprising a name of the item and a transaction price of the item, wherein the entry is based on the item catalog database; and updating, based on the transaction record, the shadow catalog database, whereby the shadow catalog database is updated automatically based on transactions and without having a direct interface between the item catalog database and the shadow catalog database.

### TECHNICAL FIELD

The present disclosure relates to maintaining catalog databases in general, and to automatic maintenance of a shadow catalog database based on transactions made using records from a catalog database, in particular.

### BACKGROUND

Electronic systems often comprise a catalog database, which retain items that can participate in a transaction. Without loss of generality, one example of such catalog database, may be a catalog database of a store, which compiles a list of the items that can be sold by the store. In some cases, the database may retain various fields for each item, such as item description, item price, item category, item serial number, or the like.

When several electronic systems are used by a same organization, each system may use a different catalog database. In some cases, the systems may not have a direct interface with one another, as implementing such interface may require substantial investment of resources in the integration, and would require the developer of a system to integrate it with a plurality of alternative complementing systems. For example, there may be many commercially available Point of Sale (PoS) systems that the organization can choose from. A developer of a complementing system to the PoS system may be required to invest substantive resources in integrating her system with all the alternative PoS systems.

In view of the above, in many cases, when a catalog of the organization is modified, each catalog database may be required to be updated separately. As the different databases may have different schemes, the update instructions used in one system may not be used as is in the second system. As a result, duplicative update operations may be performed manually by the organization in order to ensure synchronization of the different electronic systems.

### BRIEF SUMMARY

One exemplary embodiment of the disclosed subject matter is a method performed by a computing device in a computerized environment. The computerized environment may comprise a purchase transaction processor utilizing an item catalog database. The computing device may maintain a shadow catalog database. The method comprising: in response to a transaction made by the purchase transaction processor, obtaining, by the computing device, a transaction record, wherein the transaction record comprising for each item in the transaction, an entry, wherein the entry comprising a name of the item and a transaction price of the item, wherein the entry is based on the item catalog database; and updating, based on the transaction record, the shadow catalog database, whereby the shadow catalog database is updated automatically based on transactions and without having a direct interface between the item catalog database and the shadow catalog database.

Another exemplary embodiment of the disclosed subject matter is a computerized apparatus having a processor, the processor being adapted to perform the steps of: in response to a transaction made by a purchase transaction processor utilizing an item catalog database, obtaining a transaction record, wherein the transaction record comprising for each item in the transaction, an entry, wherein the entry comprising a name of the item and a transaction price of the item, wherein the entry is based on the item catalog database; and updating, based on the transaction record, a shadow catalog database, whereby the shadow catalog database is updated automatically based on transactions and without having a direct interface between the item catalog database and the shadow catalog database.

Yet another exemplary embodiment of the disclosed subject matter is a computer program product comprising a non-transitory computer readable storage medium retaining program instructions, which program instructions when read by a processor, cause the processor to perform a method comprising: in response to a transaction made by a purchase transaction processor utilizing an item catalog database, obtaining a transaction record, wherein the transaction record comprising for each item in the transaction, an entry, wherein the entry comprising a name of the item and a transaction price of the item, wherein the entry is based on the item catalog database; and updating, based on the transaction record, a shadow catalog database, whereby the shadow catalog database is updated automatically based on transactions and without having a direct interface between the item catalog database and the shadow catalog database.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIGS. 1A-1H show flowchart diagrams of methods, in accordance with some exemplary embodiments of the disclosed subject matter;

FIGS. 2A-2B show flowchart diagrams of methods, in accordance with some exemplary embodiments of the disclosed subject matter;

FIGS. 3A-3B show a schematic illustration of an exemplary environment and architecture in which the disclosed subject matter may be utilized, in accordance with some exemplary embodiments of the disclosed subject matter; and

FIG. 4 shows a block diagram of an apparatus, in accordance with some exemplary embodiments of the disclosed subject matter.

### DETAILED DESCRIPTION

One technical problem dealt with by the disclosed subject matter is to allow integration of different systems using an item catalog database. More particularly, the technical problem may be to allow synchronization of the item catalog databases used by both systems. In some cases, there may not be a direct interface between the item catalog databases of the different systems and automatic synchronization thereof may be desired.

In some exemplary embodiments, each system may utilize one or more purchase transaction processors. A purchase transaction processor may be a software/hardware implemented processor that records purchase transactions by customers. The purchase transaction processor may generate transactions records based on the purchase transactions. The purchase transaction processor may be a physical device recording the transactions, such as a cash register located at the physical location where a retail transaction is completed. Additionally or alternatively, the purchase transaction processor may be a part of an electronic-commerce system (e.g., e-commerce site) or any other digital system. Without loss of generality, the purchase transaction processor may be referred to as a PoS device.

As an example, and without limiting the scope of the disclosed subject matter, one system may be a PoS system comprising one or more PoS devices, which are used by an organization to record transactions with customers. The additional system, also referred to as a secondary system, may be, for example, a Customer Relation Management (CRM) system, a loyalty program management system, an online store system, or the like.

In some exemplary embodiments, the electronic systems may be systems associated with an organization that performs transactions in an offline manner (e.g., a grocery store, a restaurant, a book store, or the like). Such organizations may be referred to as offline organizations. In some exemplary embodiments, the offline organization may also provide for online transactions in addition to the offline transactions, such as ordering a food pickup via a website.

In some exemplary embodiments, the secondary electronic system may utilize a catalog database referred to as a shadow catalog database. The shadow catalog database, similarly to the item catalog database of the electronic system, may retain items, each of which listing a good or a service that the organization offers for sale. Each catalog database may be configured to indicate a name of the item and its selling price. Each catalog database may retain further information regarding each item, such as categorization, description, availability, or the like. In some exemplary embodiments, a catalog database may have a hierarchical structure that enables users to easily search for items the organization offers.

In some exemplary embodiments, each catalog database may be a multilingual catalog database, retaining for each good or service offered by the organization multiple items in the catalog database, in different languages. In some exemplary embodiments, it may be desired to update a multilingual shadow catalog database based on a single-language or multilingual catalog database. In some exemplary embodiments, a shadow catalog may be provided in one or more languages different than the language(s) of the catalog database.

One technical solution provided by the disclosed subject matter is to obtain transactions made by a first electronic system in order to update the shadow catalog of the secondary system. The shadow catalog database may be used by the secondary system. Based on a large enough number of transactions, it may be assumed, that each change in the catalog database is reflected in the transactions made based thereof, and as a result, the shadow catalog database may be synchronized with the item catalog database of the first electronic system; without having a direct interface between the item catalog database and the shadow catalog database. Instead, an indirect interface that is relatively simple and flexible, may be used in order to provide the synchronization. In some exemplary embodiments, the simple and flexible interface between the two systems may be used for additional purposes other than synchronization of the catalogs. Additionally or alternatively, the synchronization may be implemented using a different computing device, thereby relieving both systems from the task of updating the shadow catalog database.

Without loss of generality, the disclosed subject matter will be presented hereinbelow using the exemplary embodiment where the first electronic system is a PoS system comprising one or more PoS devices. The device responsible for updating the shadow catalog is referred to hereinbelow as the computing device.

In some exemplary embodiments, the computing device maintaining the shadow catalog database may be configured to receive records of transactions made by the PoS device. The computing device may update the shadow catalog database based on the received records of transactions. The update may include updating existing entries, deleting existing entries and adding new entries to the shadow catalog database. In some exemplary embodiments, initially the shadow catalog database may be empty and synchronized over time with the item catalog database. Additionally or alternatively, the shadow catalog database may be updated manually initially and the synchronization thereof may be implemented using the disclosed subject matter.

In some exemplary embodiments, a transaction record may comprise identifiers of items purchased in the transaction, such as but not limited to, a name of the item, a catalog number of the item, or the like. Furthermore, the transaction record may comprise a transaction price of the item, which may be the price of the item in the item catalog database as is or having a discount applied thereon. In some exemplary embodiments, any discount applied may be indicated in the entry of the item (including, for example, a discount title, a discount value (20 USD, 10%, or the like)), or the like). Additionally or alternatively, a separate entry may be provided in negative value to account for a discount for an item, such that for a single item a plurality of entries may be provided—one for the original item price and one or more additional entries for discount applied thereon. Such entries may also be based on entries in the item catalog database representing discounts and sales promotion activities. In some exemplary embodiments, the transaction record may comprise additional information about the item based on the item catalog database, such as a description of the item in the item catalog database, a category of the item as it appears in the item catalog database, or the like.

The computing device may obtain an entry of an item in the transaction record, and extract therefrom information about the item, such as a name of the item, a transaction price of the item, or the like. In some exemplary embodiments, the transaction record may be provided in a structured manner. Additionally or alternatively, the transaction record may be provided in free-text and analyzed to structured fields by the computing device.

In some exemplary embodiments, textual information in the transaction record may represent metadata useful for the disclosed subject matter. For example, an item name may be indented to reflect being a sub-item to another item, thereby reflecting metadata relating to hierarchy of the items in the transaction record. Consider the following transaction receipt in a restaurant

| | | |
|---|---|---|
| 1246503 | Hamburger | 9.90$ |
| 1247001 | ---> Mushroom | 0.50$ |
| 1247002 | ---> Onion | 0.90$ |
| 1200001 | Soda | 1.90$ |

In this transaction receipt, the mushroom and onion items are indicated as add-on items to the hamburger item. Such information may be analyzed by the computing device to infer hierarchy between items and used for updating the shadow catalog database accordingly.

In some exemplary embodiments, the computing device may update the shadow catalog database accordingly. In some exemplary embodiments, a record may be added to the shadow catalog database to reflect an item and a price of the item, based on an item in the transaction record. Additionally or alternatively, the computing device may identify an existing item in the shadow catalog database based on an item identifier in the transaction record and update a price of the existing item in the shadow catalog database, based on a transaction price in the record. In some exemplary embodiments, a transaction price may differ than the catalog price and such a difference may be inferred from analyzing the transaction record for applied discounts. Additionally or alternatively, the item price may be inferred based on a plurality of transactions. Different transactions may provide a different transaction price. The catalog price may be extracted from the plurality of transaction prices, such as the highest price, the common price, or the like.

In some exemplary embodiments, the computing device may obtain a plurality of transaction records made by the PoS system. The plurality of transaction records may be stored by the computing device in a repository. In some exemplary embodiments, the computing device may update the shadow catalog database based on the plurality of transaction records.

In some exemplary embodiments, the computing device may delete an existing item from the shadow catalog database, based on the existing item not appearing in the plurality of transaction records. In some exemplary embodiments, the computing device may delete the existing item from the shadow catalog database, based on the existing item not appearing in transaction records that are obtained in response to transactions performed on behalf of the organization within a timeframe, such as a week, a month, two months, or the like. It may be assumed that if no transaction was made with the item, such item is not being offered by the organization for sale. In some exemplary embodiments, the deletion may be semi-automatic. A user may be prompted to verify that such item is no longer being offered by the organization and after the approval of the user, the item may be deleted from the shadow catalog database. In some exemplary embodiments, user verification may be useful for determining the length of the timeframe, such as if the user rejects deletion suggestions it may be extended, until reaching a timeframe where at least a predetermined portion of the suggestions, such as about 90%, are accepted by the user.

In some exemplary embodiments, the computing device may determine a pattern of appearance of an item in a transaction based on the plurality of transaction records, and update the shadow catalog database based on the pattern of appearance of the item.

In some exemplary embodiments, each item in the shadow catalog database may indicate a category of each item. The plurality of transaction records may or may not comprise an explicit indication of the category of the item. Additionally or alternatively, implicit category information may or may not exist as well in the transaction record. The computing device may determine a category of the item based on the pattern of appearance. The computing device may determine that two items are of different categories based on the expected order of the two items in the transaction records.

As a non-limiting example, assuming that the organization is a restaurant or chain of restaurants, items in the item catalog database may be arranged in different ways: divided into food items and beverages; combination items (e.g., MCDONALD'S™ HAPPY MEAL™) or single items; entrée items, main courses, and desserts; breakfast menu, launch menu, dinner menu; or the like. Some items may be classified as add-on items to a base item, such as for example cheese, mushrooms or a fried egg, that may be ordered on top of a burger. Accordingly, these items may have a specific pattern of appearance in the transaction record, such as appearing in an expected order, e.g. entrée dishes may be ordered first so may often appear at the beginning of the transaction record, while desserts or hot beverages may often be ordered last, so may appear at the end of the transaction record. Add-on items may appear in the transaction record immediately after the base item.

The pattern of appearance may comprise an expected order of items including the item in the transaction record. The expected order may be a relative order between the item and one or more items. In some exemplary embodiments, the expected order may be a topological ordering of items based on their appearance in the plurality of transaction records. Additionally or alternatively, the expected order may relate to absolute order of the item, such as an item usually being placed at the beginning of the transaction record or at the end thereof.

In some exemplary embodiments, the pattern of appearance may comprise a relationship between items metadata, such as a correlation between the item and other items in the plurality of transaction records. As an example, if an item is ordered in all of the plurality of transaction records after a specific item or items of a same type, it may be deduced that the item is an add-on item to a base item. In such a case, the computing device may update the shadow catalog database to indicate that the item is an add-on item to the base item. Additionally or alternatively, low correlation between items may indicate the items being alternative items to one another of a same category, such as a hamburger and a hot dog. It may be noted that low correlation information may be more useful in small transactions associated with a single customer instead of a large party of customers. As another example, high correlation but not a full co-existence correlation may be indicative of items being complementary items, which may be of different categories. Consider the example of Hamburger, French Fries and Soda. Such items may be observed as having a high correlation (e.g., above a threshold of about 30%, 50%, 70%, or the like) although not a complete co-existence correlation (e.g., about at least 90%, 95%, 100%, or the like). Such an observation may be used to automatically deduce that each such item is of a different category.

In some exemplary embodiments, the computing device may determine clusters of items based on the patterns of appearance of the items. In some exemplary embodiments, items may be represented in a multidimensional feature space. The features may include features relating to correlation with other items. Based on such representation, clusters in the multidimensional feature space may be identified, where each cluster may comprise items of a similar type, or that are otherwise similar to one another. In some exemplary embodiments, a category of a cluster may be determined, such as based on categories of one or more items within the cluster whose category is known, based on user-input, based on comparison to clusters or items of a different organization, or the like. Based on the category of the cluster, the category of each item within the cluster may be set.

In some exemplary embodiments, the computing device may determine a taxonomy of the shadow catalog database based on the clusters of items. As an example, entries in the shadow catalog database may be classified in a taxonomy differentiating items of different classes. In some exemplary embodiments, the taxonomy may be a hierarchical taxonomy defining classes and sub-classes thereof. For example, items in an item catalog database of a grocery store may comprise a class of food items and a class of household products. The food class may be divided into sub-classes of fresh products, dairy, baked goods, canned and packaged goods, or the like, while the household products class may be divided into sub-classes of kitchenware, household cleaners, pharmacy products, pet supplies, or the like. Based on the clustering of products, different classes may be identified and items thereof determined. Clustering of clusters may provide for super-classes, each of which comprising several sub-classes. As a result, the fresh products cluster, the dairy cluster, the baked goods cluster may be clustered together into the super-class of “food”. While the name of each class (be it sub-class or super-class) may not be extracted from the transaction record, the categorization itself of additional items in the same class may be extracted therefrom. In some exemplary embodiments, any level of hierarchy may be implemented and the disclosed subject matter is not limited to the two-level hierarchy exemplified above.

Another technical solution is to identify a catalog database that is similar to the shadow catalog database, and determine a taxonomy for the shadow catalog database based on a taxonomy of the catalog database. The solution may further comprise updating the shadow catalog database based on the taxonomy of the shadow catalog database and based on transaction records obtained in response to transactions performed by the PoS system. Referring to the example of the restaurant, the computing device may identify a catalog database of another restaurant to determine a taxonomy for the shadow catalog database, as usually catalogs of restaurants may have the same or similar taxonomy (e.g. appetizers, salads, main dishes, drinks, hot drinks and desserts); and update the shadow catalog database based on this taxonomy.

Yet another technical solution is to update a second shadow catalog database in a different language based on the shadow catalog database.

In some exemplary embodiments, a second shadow catalog database corresponding to the shadow catalog database may be provided in a language different than the language of the shadow catalog database and of the transaction record. The computing device may update the second shadow catalog database based on the transaction record. In some exemplary embodiments, the computing device may identify a corresponding item in the second shadow catalog database that corresponds to an item in the transaction record, and update a price of the corresponding item based on the transaction price of the item in the transaction record. The computing device may determine that an item in the second shadow catalog database corresponds to an item in the shadow catalog database based on a similarity of their names. As an example, the computing device may determine that “Hamburger 160 gr” in a shadow catalog database provided in English, and “Hamburguesa 160 gr” in a second shadow catalog database provided in Spanish are the same item. Accordingly, the computing device may update information related to the item, such as a price of the item, in the second shadow catalog database; based on the transaction record or based on the shadow catalog database.

In some exemplary embodiments, the computing device may utilize a dictionary to determine translations of names of items in the transaction records, and update the second shadow catalog database based on the translations of the names of items. As an example, the computing device may determine an absence of a corresponding item in the second shadow catalog database that corresponds to an item in the transaction record. The computing device may then utilize the dictionary to determine a translation of the name of the item in the language of the transaction record to the language of the second shadow catalog database. The computing device may add a new item to the second shadow database using the translation of the name in the language of the second shadow catalog database. Additionally or alternatively, the computing device may determine a translation of the name of the item in language of the transaction record to the language of the second shadow catalog database based on a translation of another item, (e.g. if Hamburger 160 gr is translated to Hamburguesa 160 gr, then Hamburger 200 gr may be translated to Hamburguesa 200 gr. Consider also that different measurement systems may be used in different languages. Furthermore, consider that the name of the item may be a trademark having no literal translation such as WHOPPER™, and different items using the trademark may be translated using the same translation of the trademark.

One technical effect of utilizing the disclosed subject matter is to provide a simple interface for synchronizing catalog databases of different electronic systems, without relying on a direct interface between the databases. In some exemplary embodiments, a simple and lean interface between the two systems may be provided, in which only transaction records are exported from the first system to the secondary system. Based on such lean interface, the systems may be synchronized, reducing the complexity of the interface and of integrating the systems. In addition, the automatic synchronization may reduce the manual efforts required in keeping the catalog databases of the different systems in sync.

Another technical effect of utilizing the disclosed subject matter is to enable utilization of big data analytics on crowd-sourced information from a plurality of organizations. The big data analytics may be used to infer taxonomies and hierarchical categorization of items in automatically generated shadow catalog databases.

Yet another technical effect of utilizing the disclosed subject matter is to generate a universal item catalog database for several electronic systems used by different organizations from the same field. In some exemplary embodiments, different PoS systems from different organizations may use similar items, although each may have a different catalog number and/or different name thereof. The universal shadow catalog database may comprise abstraction items, each of which having different concretizations in the different catalogs. For example, a “hamburger” abstract item may be concretized as BIG MAC™ in the MCDONALD'S™ catalog and as a WHOPPER™ in the BURGER KING™ catalog. Additionally or alternatively, the universal item catalog database may define a taxonomy usable in other catalogs of the same type of organization. The taxonomy may or may not be hierarchical.

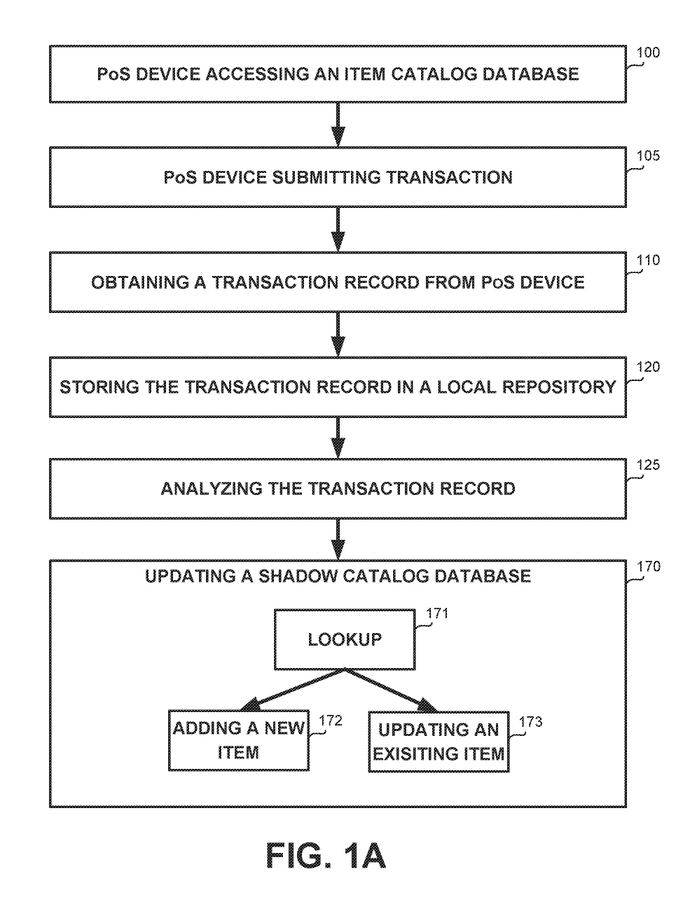

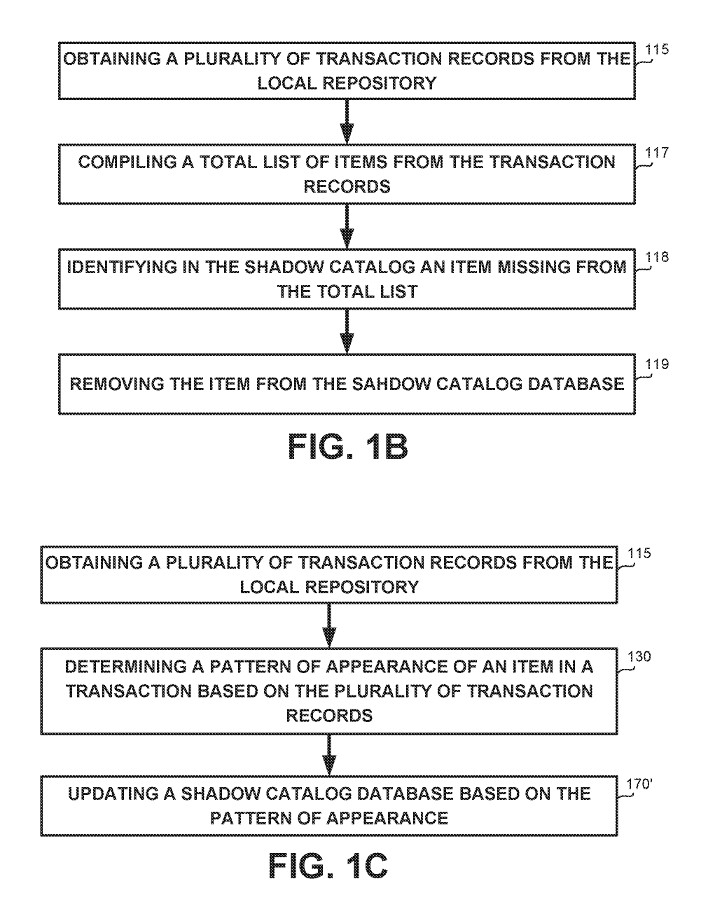

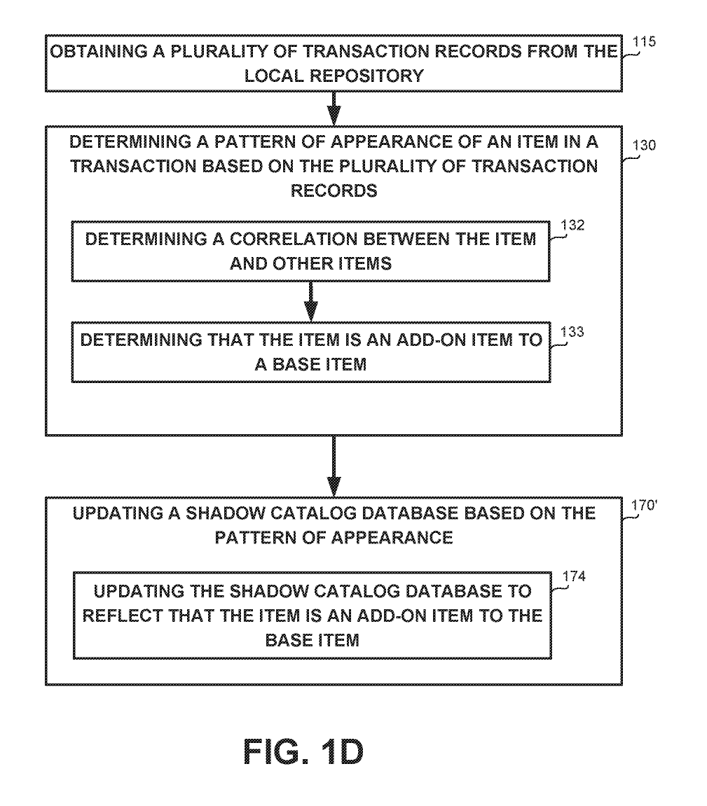

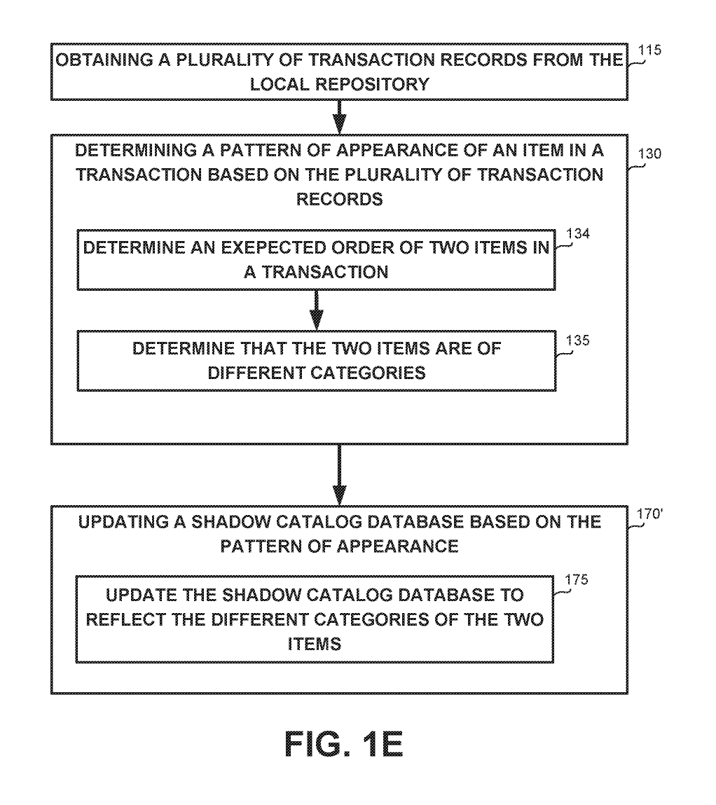

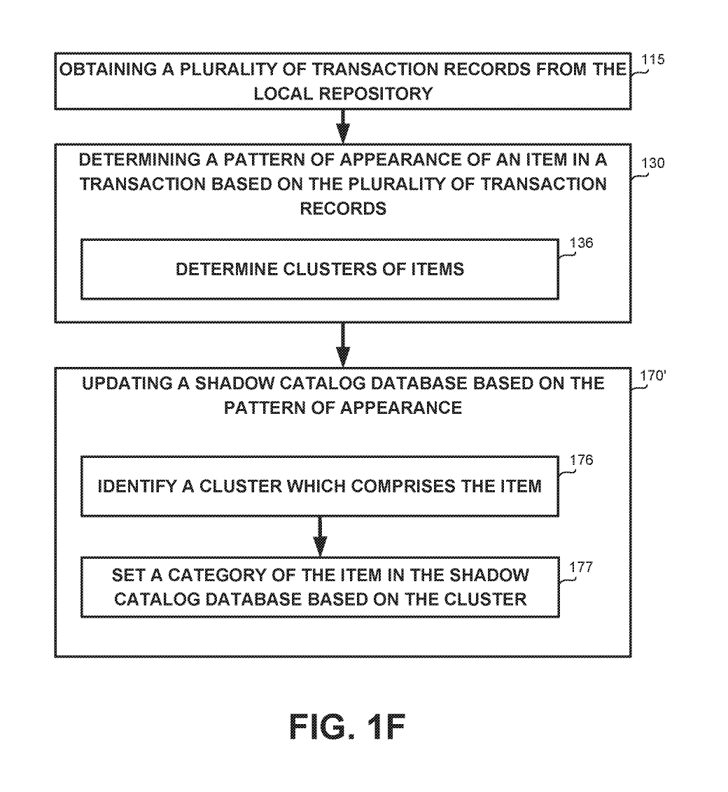

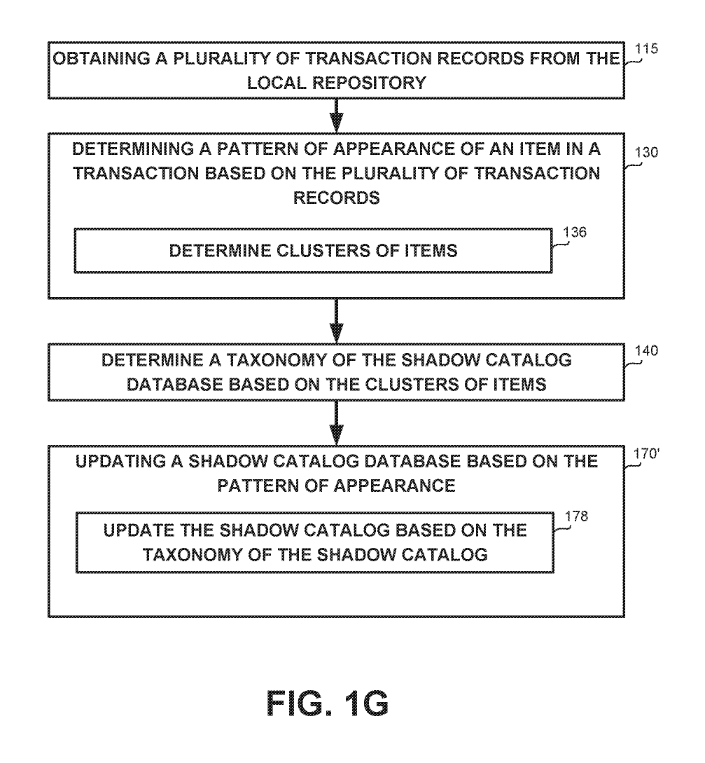

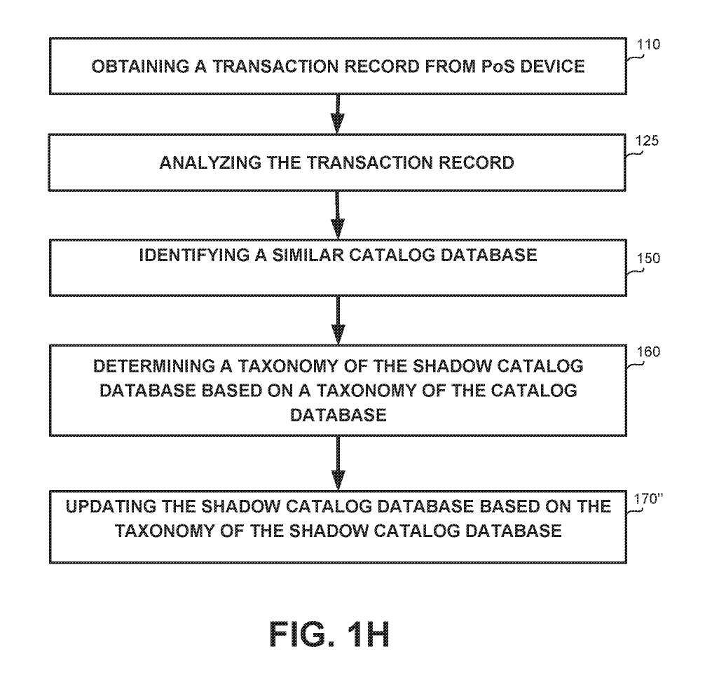

Referring now to FIG. 1A showing a flowchart diagram of a method, in accordance with some exemplary embodiments of the subject matter.

In some exemplary embodiments, a computerized environment may comprise one or more PoS devices of a PoS system associated with an organization. The PoS device may record retail transactions carried out at the PoS using the PoS device. In some exemplary embodiments, the organization may be a business entity, a non-profit entity, a school, a library, or the like.

On Step 100, the PoS device may access an item catalog database associated with the organization. The item catalog database may retain information about items or services sold at the PoS, such as names of the items, prices of the items, item identifiers, or the like.

On Step 105, the PoS device may submit a transaction. In some exemplary embodiments, the PoS device may record a transaction taking place at the PoS, such as an order by a customer inputted by an employee of organization to PoS device. The transaction may be recorded in a transaction record and committed for fulfillment. The transaction record may comprise an entry for each item in the transaction. The entry may comprise item name, transaction price, catalog number of the item, category of item. The entry may comprise free text, structured fields, or combination thereof. The free text information may be provided in a string matching a predetermined pattern, such as defined using a regular expression. The entry may be based on the item catalog database, and may or may not be based on applying discounts on one or more items.

On Step 110, a transaction record may be obtained from the PoS device. In some exemplary embodiments, a computerized device referred to as a monitor may be configured to monitor the transaction records. The monitor may be configured to maintain the shadow catalog database associated with the organization based on the monitored transaction records. The item catalog database and the shadow catalog database may not interface directly. The transaction record may be obtained by the monitor in response to a transaction performed by the PoS device. In some exemplary embodiments, the PoS device may transmit the transaction record to the monitor. Additionally or alternatively, the monitor may sniff communications between the PoS device and a central server or other remote device in order to obtain the transaction record. Additionally or alternatively, the central server or other remote device processing all transactions from PoS devices of the PoS system in a centralized manner may transmit the transaction record to the monitor. In some exemplary embodiments, only committed transactions that are completed and ready for recordation are obtained. In some exemplary embodiments, in case the transaction is later rollbacked or otherwise canceled, the monitor may disregard it and revoke any effect that was based on the analysis of the canceled transaction.

In some exemplary embodiments, the capability of the monitor to obtain a transaction record from the PoS devices may be the sole interface between a secondary system utilizing the shadow catalog database and the PoS system. In some exemplary embodiments, the interface may include obtaining transactions performed by each PoS device and not necessarily only of a single specific PoS device.

On Step 120, the transaction record may be stored in a local repository. In some exemplary embodiments, all transaction records obtained by the monitor may be stored in the local repository. The local repository may be utilized by the monitor to retrieve information from transaction records previously obtained. In some exemplary embodiments, the transaction records stored in the local repository may be stored together with a transaction time or date. In some exemplary embodiments, the local repository may be queried to obtain all transaction records occurring within a timeframe. Additionally or alternatively, the transaction record may be cleaned to only retain transactions occurring within a sliding window timeframe by periodically deleting old transactions.

On Step 125, the transaction record may be analyzed. Items and prices of the items may be identified within the transaction record. In some exemplary embodiments, the monitor may extract information from the transaction record such as but not limited to transaction price, item name, category of the item, or the like. Some information may be explicitly included in the transaction record. Some information may appear in the transaction record in an implicit manner, which allows for deduction using a set of rules. As a non-limiting example, category information may be implicitly noted, such as using indentation or other pattern-based strings.

In some exemplary embodiments, the analysis of Step 125 may include analyzing the extract item information, such as but not limited to analyzing pattern of appearance of the item, comparing the item with other items, or the like.

On Step 170, the shadow catalog database may be updated. In some exemplary embodiments, the monitor may update the shadow catalog database automatically based on the transaction record. Additionally or alternatively, the monitor may prompt a user to verify a suggested update, such as a suggested deletion of an item from the shadow catalog database.

On Step 171, the monitor may perform a lookup for an item in the shadow catalog database. In some exemplary embodiments, the lookup may be performed based on the name of the item, the catalog number of the item, another unique identifier of the item, or the like.

In case a corresponding item was not found on Step 171, Step 172 may be performed. On Step 172, the monitor may add a new item to the shadow catalog database, based on the entry of the item in the transaction record. In some exemplary embodiments, the monitor may add information related to the item to the shadow catalog database, such as the price of the item, the catalog number of the item, the name of the item in a different language, or the like. The additional information may be based on analysis performed on Step 125.

In case the monitor finds the item on Step 171, Step 173 may be performed. On Step 173, the monitor may update the existing item in the shadow catalog database, based on the entry of the item in the transaction record. In some exemplary embodiments, the monitor may update the price of the existing item in the shadow catalog database, based on a transaction price in the entry, so as to reflect an observed price change of an existing item. Additionally or alternatively, if the lookup on Step 171 was performed based on the catalog number of the item, the monitor may update a name of the existing item, based on the name of the item in the entry, so as to reflect an observed item name change of an existing item.

Referring now to FIG. 1B showing a flowchart diagram of a method, in accordance with some exemplary embodiments of the subject matter.

On Step 115, a plurality of transaction records may be obtained from the local repository. The local repository may be retained locally by the monitor or remotely in any other associated device or remote storage. In some exemplary embodiments, all transactions that were observed in a predefined sliding window timeframe, such as the last 24 hours, the last 72 hours, the last week, the last month, or the like, may be obtained. Additionally or alternatively, all transactions observed and retained may be retrieved and used for analysis.

On Step 117, a total list of items from the transaction records may be compiled. In some exemplary embodiments, the total list of items may comprise items from transaction records obtained in response to all transactions performed at the PoS within a predefined sliding window timeframe. In some exemplary embodiments, a same item may appear multiplicity of times in the transactions and would be included once in the total list of items.

On Step 118, an item missing from the total list of items may be identified in the shadow catalog database. The fact that the item is missing from the total list may indicate that the item is no longer available at the PoS. As an example, the shadow catalog database may comprise an old item that is decommissioned and no longer offered by the organization. The total list of items may exclude such decommissioned item as no transaction would include the decommissioned item, and therefore it may be deduced that the item is indeed decommissioned.

On Step 119, the item may be removed from the shadow catalog database. In some exemplary embodiments, an entry of the item in the shadow catalog database may be deleted. Related items to the item may further be deleted, such as add-on items, items correlated only to the item, or the like. In some exemplary embodiments, the removal may be automatic or semi-automatic based on user's approval of suggested deletion. In some exemplary embodiments, deletion suggestions may be compiled and provided in a batch manner to an administrator user who may accept or reject each suggestion.

Referring now to FIG. 1C showing a flowchart diagram of a method, in accordance with some exemplary embodiments of the subject matter.

On Step 130, a pattern of appearance of an item in a transaction may be determined based on the plurality of transaction records. In some exemplary embodiments, the analysis of Step 130 may be based on all or some of the transactions retained in the local repository. In some exemplary embodiments, the pattern of appearance may be a correlation between the item and other items in the transaction, an expected order of the item in relation to other items in the transaction, a topological ordering of items, co-existence correlation in transactions of the item and another item, or the like.

On Step 170′, the shadow catalog database may be updated based on the pattern of appearance. Different update actions may be performed based on the pattern of appearance, such as updating a category of the item based on the pattern of appearance, changing a hierarchical relationship of the item with another item in shadow catalog database based on the pattern of appearance, updating a category of other items in the shadow catalog database based on the pattern of appearance of the item, or the like.

Referring now to FIG. 1D showing a flowchart diagram of a method, in accordance with some exemplary embodiments of the subject matter.

On Step 132, a correlation between the item and other items may be determined. In some exemplary embodiments, the correlation may be determined based on the item and the other items appearing together in the plurality of transaction records. In some exemplary embodiments, high correlation, such as a correlation above a predetermined threshold (e.g., about 20%, about 50%, or the like), may indicate some relationship between the items. In some exemplary embodiments, correlation between the item and each other item appearing in the plurality of transaction records may be determined. For example, correlation of item “hamburger” may be computed with respect to any of the following items: “French fries”, “onion rings”, “hot dog”, “cheeseburger”, “soda”, “ice cream”, “salad”, “onion toppings”, and “bacon topping”. Based on the correlation with different items, different conclusions may be deduced automatically (e.g., “French fries”, “onion rings” and “soda” being complementary items; “cheeseburger” and “hot dog” being alternative items; “onion toppings” and “bacon topping” being add-on items thereof; etc.).

On Step 133, based on a correlation determined on Step 132, between the item and another item, a determination that the item is an add-on item to a base item (or vice versa) may be performed. For example, in case of a strong correlation, such as that “onion toppings” never appear without item “hamburger”, it may be determined that the “onion toppings” item is an add-on item to a base item, “hamburger”. In some exemplary embodiments, the same add-on item may be used with regards to several potential alternative base items (e.g., “hamburger”, “cheeseburger”). Using correlation analysis, such alternative base items and add-on items may be identified automatically.

On Step 174, the shadow catalog database may be updated to reflect that the item is an add-on item to the base item (or vice versa). In some exemplary embodiments, a category of the item in the shadow catalog database may be updated to reflect that the item is an add-on item. Additionally or alternatively, the item may be linked to the base item in the shadow catalog database or to a set of alternative base items.

In some exemplary embodiments, prices of the item and the base item may be updated. As an example, consider a case where the transaction price of the “hamburger” with the “onion toppings” is provided in a cumulative manner not dividing the costs between the ingredients. The total transaction price of both items may be used to determine a price of one of the items using an existing price of the other item as appearing in the shadow catalog database. For example, consider the “hamburger” being listed as 20 USD. If the transaction price of both items is 25 USD together (either explicitly or implicitly, such as in case the transaction price of the “hamburger” is 25 USD and the item price of the add-on item is null), then the item price of the “onion toppings” is computed to 5 USD.

Referring now to FIG. 1E showing a flowchart diagram of a method, in accordance with some exemplary embodiments of the subject matter.

On Step 134, an expected order of two items in a transaction may be determined. The expected order may be determined based on the pattern of appearance of the item and the other item in the plurality of transaction records. In some exemplary embodiments, the expected order of the two items may be determined based on the order of the two items in the plurality of transaction records. If the two items appear in a certain order in a high percentage of the plurality of transaction record, such as about 70% or more, the two items may be likely to appear in the certain order in each transaction obtained by the PoS device.

On Step 135, the two items may be determined to be of different categories. In some exemplary embodiments, the monitor may determine that the two items—the item and the other item—are of different categories based on the expected order of the two items. In some exemplary embodiments, in case the correlation is above a predetermined threshold, and an expected order is observed in a relatively high percentage of the occurrences, such as above 70% of the occurrences, it may be inferred that the items are of different categories. Additional information may be determined based on the expected order of the two items, such as determining that the other item is a complementary item to the item. Additionally or alternatively, certain order may be indicative of the items being a base item and add-on item. Additionally or alternatively, an absence of a persistent ordering may be indicative that the items are of a same category.

Additionally or alternatively, the absolute order of the item, such as being relatively in the beginning in all transactions or being relatively in the end, may be useful to deducing to which category the item is associated. For example, appetizers may appear in the beginning, while deserts and drinks—at the end.

On Step 175, the shadow catalog database may be updated to reflect the different categories of the two items. In some exemplary embodiments, a category of the item may be determined based on the category of the other item. In some exemplary embodiments, one of the items' categories may be defined, and the other item's category may be unknown. In some exemplary embodiments, a category of an item may be a variable that can receive any value of a domain which comprises the set of potential categories. The variable may be updated to exclude the category of the other item thereby reducing the number of potential categories for the item. In some exemplary embodiments, using sufficient amount of transactions, such analysis may be used to deduce a single category for the item after excluding all other potential categories. Additionally or alternatively, the user may manually select between the alternative possible categories in case an automatic final conclusion cannot be drawn from the data.

Referring now to FIG. 1F showing a flowchart diagram of a method, in accordance with some exemplary embodiments of the subject matter.

On Step 136, clusters of items may be determined. In some exemplary embodiments, for each item a multidimensional vector of features may be generated. As an example, the multidimensional vector may comprise a set of correlation values for the item with other items (e.g., the first feature—correlation with item #1, the second feature—correlation with item #2, etc.). The multidimensional vector may comprise a feature representing the price or price category (e.g., cheap, medium, expensive, etc.). Additional features relating to the item may include absolute expected order defined based on topological ordering of the items, average time of day of transaction (e.g., differentiating breakfast menu from dinner menu), or any other feature descriptive of the pattern of appearance of the item or of the customers consumption of the item. A cluster analysis method may be applied on the multidimensional space comprising vectors for each observed item. The cluster analysis may be, for example, connectivity-based clustering, centroid-based clustering, k-means clustering, distribution-based clustering, density-based clustering, or the like. Each cluster may be considered as indicative of a same category of items in the cluster. The category may be a class, a sub-class, a super-class, or the like. In some exemplary embodiments, the cluster analysis may be performed once and updated upon receiving additional observations. Additionally or alternatively, the cluster analysis may be re-performed or updated periodically.

In some exemplary embodiments, the cluster analysis may be a semi-supervised learning process, which is updated based on verified category information of the items. Additionally or alternatively, a supervised machine learning technique may be applied to generate a classifier which receives a multidimensional vector and predicts a label. The training dataset may comprise items with verified categories.

In some exemplary embodiments, each category may have a different classifier, which classifies the item as either being a member of the category or not. Each such classifier may be trained on all observed instances whose category is known.

On Step 176, a cluster which comprises the item may be identified. The cluster may be identified by adding the vector representing the item to the space and locating a cluster comprising the item. Additionally or alternatively, the closest cluster to the item may be considered as the item's cluster. Additionally or alternatively, in case no cluster comprises the item, the item may be considered as not being associated with any cluster. In some exemplary embodiments, the trained classifier may be utilized. A predicted label provided by the classifier when a vector is fed thereto may be considered a designation of the cluster of which the item is a member. Additionally or alternatively, a category-specific classifier may be used to determine a category of the item. In some exemplary embodiments, in case several category-specific classifiers return positive prediction, a confidence measurement may be used to select between the potential categories. Additionally or alternatively, in case of an hierarchical taxonomy of categories, such a result may indicate the category at different hierarchical levels.

On Step 177, a category of the item in the shadow catalog database may be set based on the cluster determined on Step 176. In some exemplary embodiments, the cluster may be predeterminely associated with a category, such as based on user input or training data. Additionally or alternatively, the category may be determined based on a category of other items in the cluster, such as a category of a majority items in the cluster.

Referring now to FIG. 1G showing a flowchart diagram of a method, in accordance with some exemplary embodiments of the subject matter.

On Step 140, a taxonomy of the shadow catalog database may be determined based on the clusters of items. In some exemplary embodiments, the shadow catalog database may be separated into different classes according to the clusters of items. In some exemplary embodiments, the determined taxonomy may be hierarchical, based on clusters and clusters of clusters. In some exemplary embodiments, different classifiers may be used to label classes at different hierarchical level, thereby providing alternative labels to the same item. As an example, a higher-level classifier may classify item “BUDWISER™” as a drink, while a lower-level classifier may classify the item as a beer.

On Step 178, the shadow catalog database be updated based on the taxonomy of the shadow catalog database. Each cluster of items may be represented separately in the shadow catalog database.

Referring now to FIG. 1H showing a flowchart diagram of a method, in accordance with some exemplary embodiments of the subject matter.

On Step 150, a catalog database that is similar to the shadow catalog database being updated may be identified. In some exemplary embodiments, the similar catalog database may be determined based on shared items between the catalog database and the shadow catalog database. Similarity analysis between catalogs may be performed using, for example, similarity in the number of items, similarity in the names of items (e.g., accounting for potential meaningless textual differences between “Hot Dog” and “hotdog”, between “Burger 220 gr” and “Hamburger 220”, or the like), similarity in categories of items, similarity in the subject matter of the items or their types (e.g., food items, clothing items, book items, or the like), similarity relating to popular items (e.g., items appearing in transactions above a predetermined threshold, which may be an absolute threshold or a relative threshold; In some exemplary embodiments, occurrences of items in transactions may be normalized to indicate a popularity rating between 0 and 1 of each item), or other measureable similarities between the catalog databases based on their content or metadata. The similar catalog database may be a second shadow catalog database maintained by the computing device. Additionally or alternatively, the similar catalog database may be a second item catalog database used by a second electronic system associated with the organization or a similar organization. Additionally or alternatively, the similar catalog database may be automatically generated by a computerized system or may be manually defined by a user.

On Step 160, a taxonomy of the shadow catalog database may be determined based on a taxonomy of the similar catalog database. In some exemplary embodiments, the shadow catalog database and the similar catalog database may have the same taxonomy or similar taxonomy. The taxonomy of the similar catalog may be defined (e.g., either automatically or manually) and based thereof, the taxonomy of the shadow catalog database (or portion thereof) may be determined. In some exemplary embodiments, classifications of similar items may be copied from the predetermined taxonomy to the determined taxonomy. Additionally or alternatively, hierarchical relationships between classes may be imported into the taxonomy of the shadow catalog database. In some exemplary embodiments, the potential categories of items may be copied so as to define the domain of categories for each item in the shadow catalog database even in case where the specific category of each item is not necessarily extractable from the taxonomy of the similar catalog database.

On Step 170″, the shadow catalog database may be updated based on the taxonomy of the shadow catalog database. In some exemplary embodiments, a hierarchical structure of the shadow catalog database may be updated based on the taxonomy. Additionally or alternatively, items in the shadow catalog database may be classified according to the taxonomy.

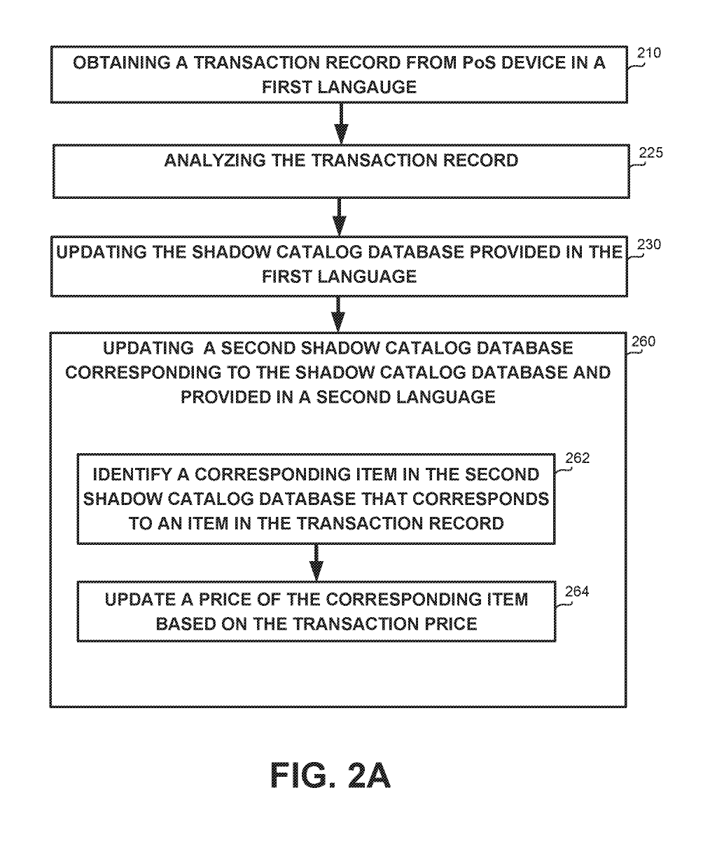

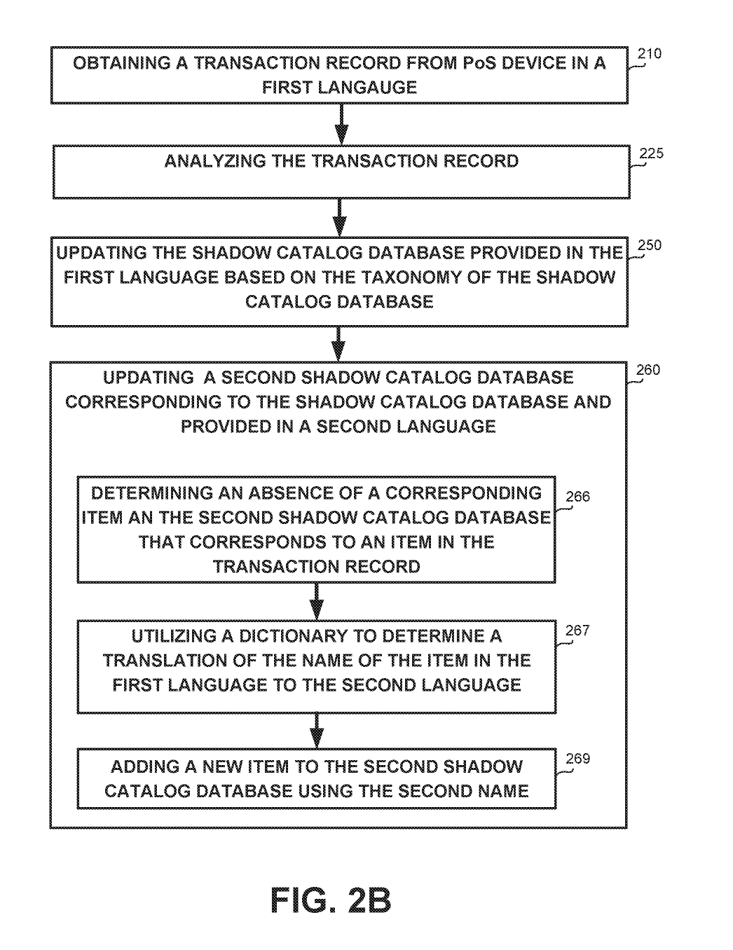

Referring now to FIG. 2A showing a flowchart diagram of a method, in accordance with some exemplary embodiments of the subject matter.

On Step 210, a transaction record in a first language may be obtained from a PoS device. In some exemplary embodiments, the transaction record may obtained such as on Step 110 in FIGS. 1A and 1H, or as a part of Step 115 in FIGS. 1B-1G. In some exemplary embodiments, the PoS device may be multilingual. Additionally or alternatively, the PoS device may be configured to use solely the first language. The PoS system to which the PoS device is connected may be multilingual such that some PoS devices may be multilingual themselves or operate in a different language, such as based on the deployed location and common language in its vicinity.

On Step 225, the transaction record may be analyzed, such as on Step 125 of FIGS. 1A and 1H. Items and prices of the items may be identified within the transaction record.

On Step 230, the shadow catalog database provided in the first language may be updated such as described in Step 170 of FIG. 1A, Step 119 in FIG. 1B, Step 170′ in FIGS. 1C-1G, Step 170″ of FIG. 1H, or the like.

On Step 260, a second shadow catalog database corresponding to the shadow catalog database may be updated. In some exemplary embodiments, the second shadow catalog database may be provided in a second language. The second shadow catalog database may be used by a second electronic system (e.g. a different system operating in the second language, utilized by users speaking the second language, or the like) or the by same electronic system as the shadow catalog database. In some exemplary embodiments, the second shadow catalog database may be associated with the same organization (for example, different shadow catalog databases of MCDONALD'S™ restaurants over the world, operating in different languages but share the same items).

It may be noted that the second shadow catalog database may be updated directly as the shadow catalog database, based on the transaction records obtained from the PoS device (for example, Hamburger may be used both in English and in French). However, in some cases, because of the different languages, such direct updating may not be possible and additional processing may be performed.

On Step 262, a corresponding item to an item in the transaction record may be identified in the second shadow catalog database. The corresponding item may be identified based on a shared catalog number with the item in the transaction record. Additionally or alternatively, the corresponding item may be identified using a translation of the item name in the transaction record to the second language.

On Step 264, a price of the corresponding item may be updated in the second shadow catalog database, based on the transaction price of the item. In some exemplary embodiments, the second shadow catalog database may indicate prices of the items in a different currency than the transaction record. The price update may be based on the exchange rate and may be modified based on predetermined rules, such as to the next 0.90 number (e.g., instead of 5.70, set the price at 5.90), rounding the price, or the like.

Referring now to FIG. 2B showing a flowchart diagram of a method, in accordance with some exemplary embodiments of the subject matter.

On Step 266, it may be identified that the second shadow catalog database does not comprise a corresponding item to an item in the transaction record. In some exemplary embodiment, the transaction record may comprise one or more items that do not exist in the second shadow catalog database. Such items may be determined based on searching for each item in the transaction record within the second shadow catalog database. Such items may be new items that were added to the item catalog database, and were just now added to the shadow catalog and are also to be added to the second shadow catalog database. Additionally or alternatively, the item may pre-exist in the shadow catalog database and not exist in the second shadow catalog database as a result of manual update of each catalogs, different automated updating of the catalogs, or the like.

On Step 267, a dictionary may be utilized to determine a translation of the name of the item in the first language to the second language. In some exemplary embodiments, the dictionary may be a specialized dictionary that includes word from the specific field of the organization. For example, a culinary dictionary may be utilized to translate names of items related to restaurants. Additionally or alternatively, the translation of the name may be determined based on other names of items in the second shadow catalog database. In some exemplary embodiments, the dictionary may include translations of brand names and trademarks of the organization from one language to another. Based on the dictionary, a second name of the item in the second language may be determined. As an example, “Sazurke” may be determined to be the Spanish name of the item corresponding to “pickles” in the transaction record which was provided in English.

On Step 269, a new item may be added to the second shadow catalog database using the second name. A price of the item may be set based on the transaction price of the item. For example, a record for pickles may be added to a Spanish shadow catalog database for the exemplified hamburger restaurant, using the second name “Sazurke”, with the transaction price of pickles from the transaction record.

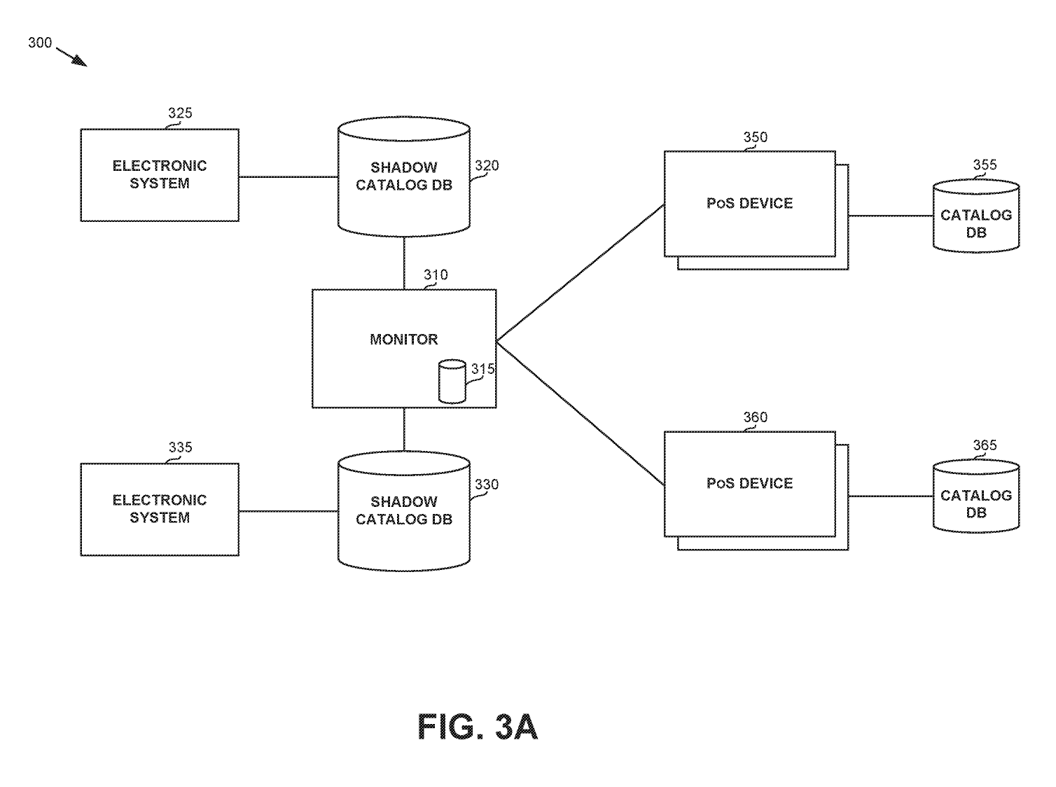

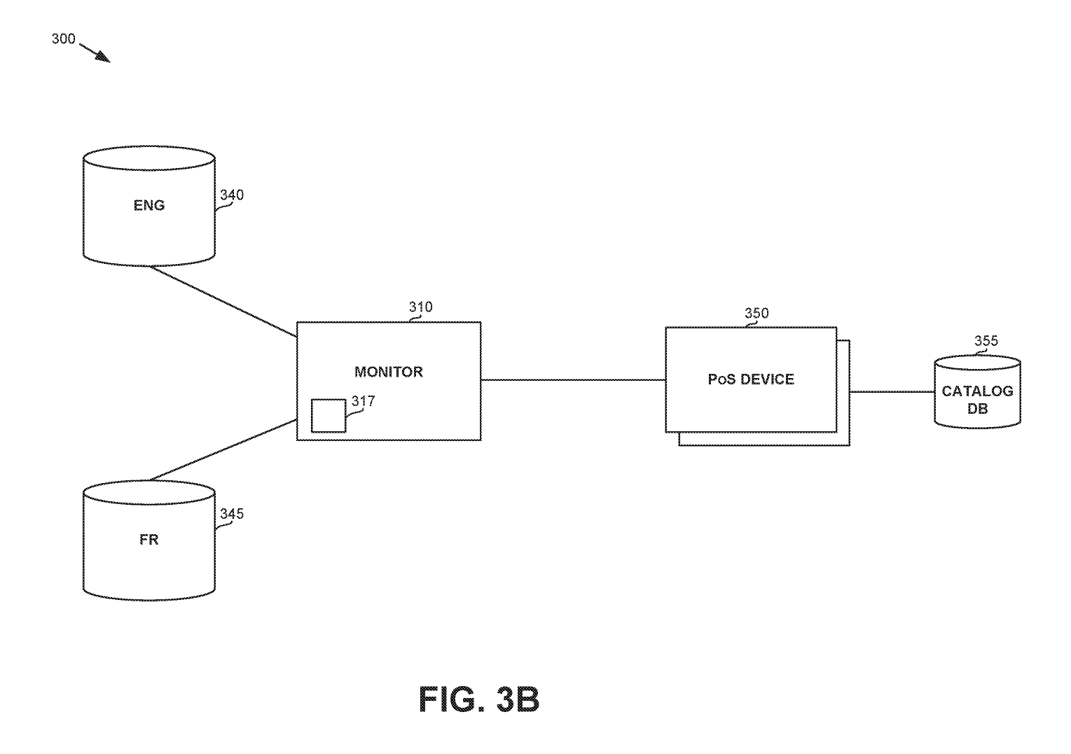

Referring now to FIG. 3A showing a schematic illustration of an exemplary environment and architecture in which the disclosed subject matter may be utilized, in accordance with some exemplary embodiments of the disclosed subject matter.

In some exemplary embodiments, an Environment 300 may comprise a Monitor 310 such as a computing device, a server, a personal computer, a mobile device, or the like. Monitor 310 may obtain information from one or more PoS systems, each comprises one or more PoS Devices. As an example, a first PoS system may comprise PoS Device(s) 350, and a second PoS system may comprise PoS Device(s) 360.

In some exemplary embodiments, a PoS system comprising PoS Device 350 may be associated with an organization. The organization may be a business entity, a non-profit entity, or the like. PoS Device 350 may process retail transactions performed at a PoS of the organization, such as a cash register, a self-checkout machine, a cashier, an online website, a computerized devise with PoS softwares, or the like. In some exemplary embodiments, PoS Device 350 may be associated with a PoS that has a physical location at which the transaction occurs and to where the customer arrives, and is generally referred to as an offline PoS.

In some exemplary embodiments, PoS Device 350 may be operated by a human user, such as a merchant of the organization. PoS Device 350 may record each transaction performed at the PoS. PoS Device 350 may be configured to perform further operations related to the transaction, such as for example, calculating a total amount owed by the customer performing the transaction, indicating the total amount to the costumer, preparing an invoice for the customer, which may be a cash register printout, indicating the options for the customer to make payment. PoS Device 350 may be utilized to receive a payment from the customer to the merchant in exchange for goods or after provision of a service. PoS Device 350 may be utilized to perform transactions using credit cards via a clearing service. After receiving payment, PoS Device 350 may be configured to issue a receipt for the transaction. The receipt for the payment may be printed, dispensed, sent electronically or the like.

In some exemplary embodiments, PoS Device 350 may utilize a Catalog Database 355 of the organization. The user using PoS Device 350 may select items from items available and defined at Catalog Database 355 in order to define a transaction based on the customers requests. Additionally or alternatively, PoS Device 350 may be an interactive device, where the user is the customer. Catalog Database 355 may comprise goods and services supplied by the organization. In some exemplary embodiments, Catalog Database 355 may also comprise discounts and sale promotions offered by the organization. Catalog Database 355 may comprise information about the items and the services as displayed to costumers of the organization. Catalog Database 355 may be used to display to the customers and potential customers the items offered by the organization, such as in a digital billboard, a digital menu on a tabloid computer, a web-based digital menu in a website of the organization, or the like.

In some exemplary embodiments, PoS Device 350 may be configured to issue a transaction record of each transaction performed at the PoS. The transaction record may be printed out in a hardcopy receipt detailing the transaction. Additionally or alternatively, the transaction record may be a digital record of the transaction used for data analytics purposes, inventory update, business activity monitoring, or the like. The transaction record may comprise an entry for each item or service purchased in the transaction. The entry may be based on Catalog Database 355. The entry may comprise an identifier of the item, such as a name of the item, a catalog number of the item, a combination thereof, or any other identifier of the item as used in Catalog Database 355. The entry may further comprise a transaction price of the item.

In some exemplary embodiments, PoS Device 350 may transmit transaction records of transactions it performs to Monitor 310. In some exemplary embodiments, transmission of the transaction record may be performed in a centralized location, such as a central server of the PoS system receiving all transaction records from PoS Devices 350. Additionally or alternatively, a sniffing component may be used to monitor transaction records sent towards the central server and forward such records to Monitor 310. Additionally or alternatively, Monitor 310 may comprise the sniffing component.

In some exemplary embodiments, transmission of transaction records from the PoS system to Monitor 310 may be implemented by a lean interface integrating the PoS system with Monitor 310, with a secondary electronic system, or the like.

In some exemplary embodiments, Monitor 310 may maintain a Shadow Catalog Database 320. Monitor 310 may update Shadow Catalog Database 320, based on transaction records obtained from PoS Device 350, without having a direct interface between Catalog Database 355 and Shadow Catalog Database 320. In some exemplary embodiments, the database scheme of Shadow Catalog Database 320 may differ from the scheme of Catalog Database 355.

In some exemplary embodiments, Shadow Catalog Database 320 may be utilized by an Electronic System 325. Electronic System 325 may be used by the organization activating PoS Device 350, such as for example, an online store system operated by the organization, a CRM, a loyalty program management system, or the like. Additionally or alternatively, Electronic System 325 may not belong directly to the organization. As an example, Electronic System 325 may be a system aggregating information from several organizations, such as, without limitation, an aggregated online store allowing users to purchase items from plurality of different offline vendors, a demand analysis system for analyzing aggregated supply and demand in the market, or the like.

In some exemplary embodiments, Monitor 310 may add new items and prices thereof to Shadow Catalog Database 320, based on entries of the items in the transaction record. Additionally or alternatively, Monitor 310 may identify existing items in Shadow Catalog Database 320 based on entries in the transaction record, and update prices of the existing items in Shadow Catalog Database 320, based on their transaction price.

In some exemplary embodiments, Monitor 310 may utilize a Local Repository 315 to retain transaction records obtained from PoS Devices, such as PoS Device 350. Local Repository 315 may store further information about the transaction records obtained from the PoS device, such as a date of the transaction record (or any other time information), information regarding the customer whom behalf the transaction record was issued (such as loyalty program membership), any metadata information of the transaction record, or the like. In some exemplary embodiments, Local Repository 315 may retain transaction records occurring within a specific timeframe, such as by deleting old transaction records, or transaction records from special timeframe (such as for example transaction records obtained in a sale season that are no longer relevant may be deleted). In some exemplary embodiments, all transactions observed in a sliding window timeframe may be obtained from Local Repository 315.

In some exemplary embodiments, Monitor 310 may update Shadow Catalog Database 320 based on transaction records retained in Local Repository 315. As an example, Monitor 310 may delete an existing item from Shadow Catalog 320, based on the existing item not appearing in all transaction records observed in a predefined recent timeframe (e.g., last month, last season, last year, or the like) in Local Repository 315. Additionally or alternatively, the transaction records retained in Local Repository 315 may be utilized to extract a pattern of appearance of items, correlation of items, or the like.

In some exemplary embodiments, Monitor 310 may utilize transaction records retained in Local Repository 315, to determine a pattern of appearance of an item in a transaction obtained by PoS Device 350, based on how the item appears in other transaction records. The pattern of appearance may comprise an expected order of items in a transaction based on a plurality of transaction records. Additionally or alternatively, the pattern of appearance may comprise a location of the item within the plurality of transaction records, the pattern of information appearing in each entry in the plurality of transaction records, or the like.

As another non-limiting example, assuming that Electronic System 325 is an online website of a fashion and beauty retailer (e.g., ASOS™). The online website may utilize Shadow Catalog Database 320 to retain records of available items for sale in one or more organizations utilizing PoS Device 350 and/or other PoS devices from other PoS systems (e.g., ASOS™ may retain an online catalog offering products from different fashion and beauty stores, either online or offline). Monitor 310 may be activated by the retailer and may be used to update Shadow Catalog Database 320 of the online website based on one or more PoS systems associated with organizations whose product are offered for sale on the online website (e.g., different fashion and beauty stores for men and women). Transaction records obtained by Monitor 310 from the PoS devices may comprise an entry for each product purchased at the PoS. The entry may comprise the product name, the transaction price of the product, information about the product (e.g., size, color, type, description, or the like), the quantity of the same product purchased at the transaction, the total price, or the like. Monitor 310 may update Shadow Catalog 320 based on the transaction records, such as by adding new entries for new products, updating prices for existing products, updating availability of items in specific sizes, deleting pre-existing items no longer being sold, or the like.

In some exemplary embodiments, Monitor 310 may update Shadow Catalog 320 based on the pattern of appearance of the item. In some exemplary embodiments, Monitor 310 may determine a correlation between the item and other items in Shadow Catalog 320, based on the pattern of appearance. Monitor 310 may determine that the item is an add-on item to a base item based on a correlation between the item and the base item. Monitor 310 may update Shadow Catalog 320 to reflect that the item is an add-on item to the base item. In some exemplary embodiments, Monitor 310 may determine that two items are of the same category or of different categories based on the expected order of the two items. Monitor 310 may update Shadow Catalog 320 to reflect the different categories of the two items. Additionally or alternatively, Monitor 310 may determine a category of an item based on a pattern of appearance of the item in a plurality of transaction records. In some exemplary embodiments, Monitor 310 may determine clusters of items based on the patterns of appearance of the items. Each cluster may be indicative of a same category of items in the cluster. Monitor 310 may identify a cluster which comprises the item; and set a category of the item in Shadow Catalog 320 based on the cluster. Additionally or alternatively, Monitor 310 may determine a taxonomy of Shadow Catalog 320 based on the clusters of items.

Referring to the example of the online retailer website, if a specific shirt, a specific pair of trousers, and a specific pair of shoes are highly correlated in the plurality of transaction records (i.e. often purchased together), they may be clustered together as on outfit to be sold as “Shop the Look” category in Shadow Catalog Database 320. Additionally or alternatively, a watch and a replaceable face thereof may be identified as having a high correlation and the replaceable face may be identified automatically as the add-on product. It will be noted that in such a case, an add-on product may be purchased without purchasing the base item in the same transaction. However the add-on item may have utility only for a customer having the base item itself. Additionally or alternatively, shirt items may be clustered together based on their metadata and correlation with other items. For example, it may be more common to shop for a shirt with a trouser than for a shirt with a sock. Additionally or alternatively, products may be classified as products for men or products for women based the items being clustered together in the plurality of transaction records, as products for a certain gender are highly expected to be ordered together. Such a classification may be performed based on the metadata about the item in the plurality of transaction records (e.g., the sizing measurement may be specific for men or women, the products being clustered with other gender specific products, or the like) or based on correlation of the items with other items (e.g., women may tend to purchase shoes with shirts more often than men).

In some exemplary embodiments, a second PoS system comprising PoS Device(s) 360, may be connected to Monitor 310, similarly to the PoS system comprising PoS Device(s) 350. Monitor 310 may obtain transaction records of transactions performed by PoS Device 360. PoS Device 360 may utilize a Catalog Database 365, to perform its activity. Monitor 310 may be configured to maintain and update a second shadow catalog database associated with PoS Device 360, such as Shadow Catalog Database 330, without having a direct interface to Catalog Database 365. Monitor 310 may update Shadow Catalog 330, based on transaction records obtained from PoS Device 360. In some exemplary embodiments, Shadow Catalog 330 may be utilized by an Electronic System 335. Electronic System 335 may be utilized by the organization activating PoS Device 350, or by a different organization. Electronic System 335 and Electronic System 325 may not have a direct interface with one another. Additionally or alternatively, in some cases, Electronic System 325 and Electronic System 335 may be the same system.

Referring again to the example of an online retailer website, Electronic System 335 may be another online website of a fashion and beauty retailer (e.g., NEXTDIRECT™), and may utilize Shadow Catalog Database 330 to retain records of available items for sale in one or more same or other organizations utilizing PoS Device 360 and/or the other PoS devices. As an example, NEXTDIRECT™ may retain an online catalog offering products from different stores, some shared with ASOS™ and some may not be shared therewith. Monitor 310 may update Shadow Catalog Database 330 of NEXTDIRECT™ website based on one or more PoS systems associated with organizations that offer their products for sale on NEXTDIRECT™ (e.g., different children fashion stores in UK, homeware stores, or the like).

In some exemplary embodiments, Monitor 310 may determine a taxonomy of Shadow Catalog 330 based on a taxonomy Shadow Catalog 320, or based on a taxonomy of another catalog database that is similar to Shadow Catalog 330. Monitor 310 may update Shadow Catalog 330 based on the determined taxonomy. For example, the taxonomy of NEXTDIRECT™ may be inferred based on the taxonomy of ASOS™, while adding a category for children separated into boys and girls sub-categories, each of which having the same classification for types of products.

Referring now to FIG. 3B showing a schematic illustration of an exemplary environment and architecture in which the disclosed subject matter may be utilized, in accordance with some exemplary embodiments of the disclosed subject matter.

In some exemplary embodiments, Monitor 310 may maintain two or more shadow catalog databases in different languages, such as Shadow Catalog Database 340 retain a catalog in English and Shadow Catalog Database 345 retain a catalog in French. Additionally or alternatively, Monitor 310 may maintain one or more multilingual shadow catalog databases. Monitor 310 may update Shadow Catalog Database 340 and Shadow Catalog Database 345, based on transaction records obtained from PoS Device 350, without having a direct interface between Catalog Database 355 and Shadow Catalog 340 or Shadow Catalog 345. It will be noted that Shadow Catalog Databases 340 and 345 may be retained on a same digital storage, and may be separated logically from one another. Additionally or alternatively, the databases may be separated physically from one another and retained on different storage devices.

In some exemplary embodiments, PoS Device 350 may operate in a single language similar or different from the languages Shadow Catalog Database 340 and Shadow Catalog Database 345 are provided in. Without limiting the scope of the disclosed subject matter, it is assumed hereinbelow that transaction records obtained from PoS Device are provided in the same language as Shadow Catalog Database 340 (e.g. English), and different than the language of Shadow Catalog Database 345 (e.g. French).

In some exemplary embodiments, Monitor 310 may update Shadow Catalog Database 340 directly based on transaction records obtained from PoS Device 350, as previously described in updating shadow catalog databases in FIG. 3A.

In some exemplary embodiments, Monitor 310 may identify a corresponding item in Shadow Catalog 345 that corresponds to an item in a transaction record obtained from PoS Device 350, based on a similarity of the names of the items, same catalog numbers, or the like. Monitor 310 may update a price of the corresponding item based on the transaction price of the item in the transaction record. Additionally or alternatively, Monitor 310 may determining an absence of a corresponding item in Shadow Catalog 345 that corresponds to an item in the transaction record. Monitor 310 may utilize a Dictionary 317 to determine a translation of the name of the item in the language of transaction records obtained from PoS Device 350 to the language of Shadow Catalog 345 to determine a second name of the item in that language (e.g., French). Monitor 310 may add a new item to Shadow Catalog 345 using the second name.

Referring to the example of the fashion and beauty online retailers, Monitor 310 may maintain different catalogs for ASOS™ in different countries, (e.g., www.asos.fr may be maintained in French and www.asos.uk may be maintained in English). Each catalog may retain available items in cooperated fashion stores in the relevant country or in the whole of Europe. Shadow Catalog Database 340 may retain products and their information in English, with prices in GBP, while Shadow Catalog Database 345 may retain products and their information in French, with prices listed in EUR. The transaction records may be obtained from one or more PoS systems of a store located in Europe, each PoS Device may operate in a different language based on its location. Assuming PoS device 350 is located at a store in UK, transaction records may be obtained in English. Some items information may not be translated, such as brands names, discounts metadata, or the like. Other information may be translated using Dictionary 317, which may be an English-French dictionary. Dictionary 317 may be a special dictionary for fashion and beauty terms. Furthermore, Dictionary 317 may comprise a sizing converting list for converting measurements from UK sizes to EU sizes. The prices may be further updated to fit in the right currency. In some exemplary embodiments, branding translations may be provided in Dictionary 317.

In some exemplary embodiments, Monitor 310 may be configured to update both Shadow Catalog Databases 340, 345 based on transactions issued from PoS Device(s) 350 that are located in certain geographic locations, while based on other transactions, only one of the two may be updated. For example, French regional stores may be used to update Shadow Catalog Database 345 and not Shadow Catalog Database 340. The same may be true to PoS devices that are deployed in Belgium, albeit the fact that they may use a German catalog.

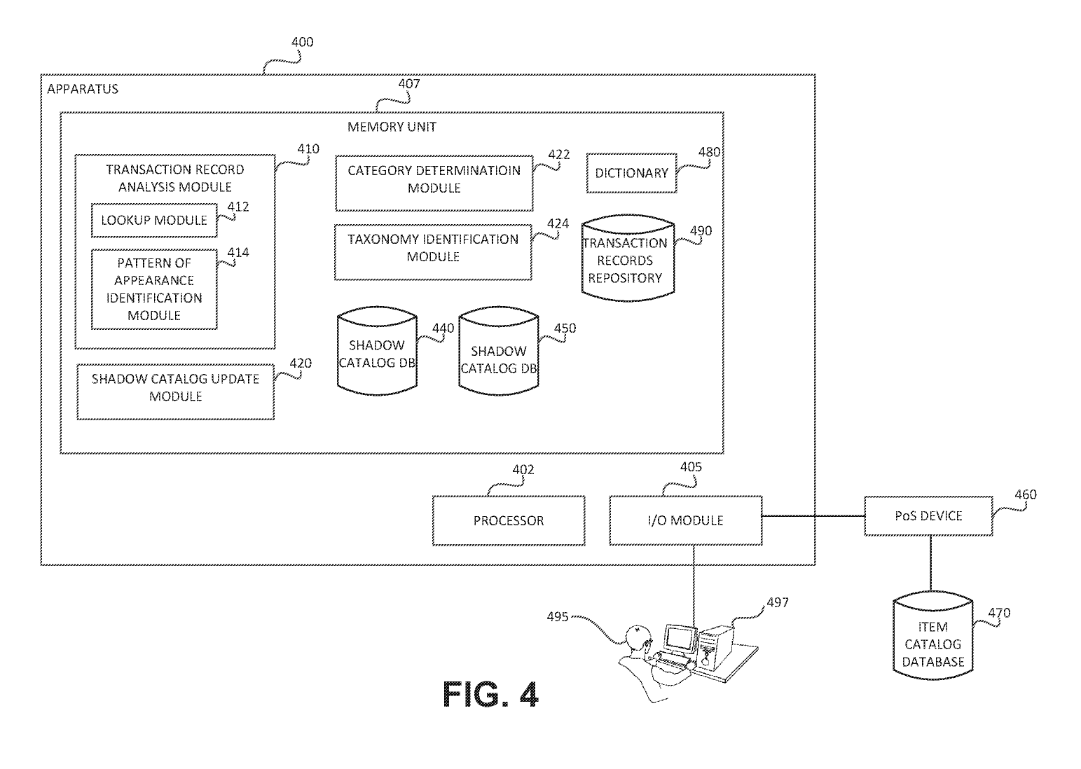

Referring now to FIG. 4 showing a block diagram of an apparatus in accordance with some exemplary embodiments of the disclosed subject matter. In some exemplary embodiments, Apparatus 400 may be a monitor, such as 310 of FIG. 3A/3B.

In some exemplary embodiments, Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 400 or any of it subcomponents.

In some exemplary embodiments of the disclosed subject matter, Apparatus 400 may comprise an Input/Output (I/O) Module 405. Apparatus 400 may utilize I/O Module 405 as an interface to transmit and/or receive information and instructions between Apparatus 400 and external I/O devices, such as a Workstation 497, a PoS Device 460, other computing devices (not shown), an electronic system (not shown), or the like.

In some exemplary embodiments, I/O Module 405 may be used to provide transaction records from PoS Device 460 or other devices. User 495 may use Workstation 497 to input a basic shadow catalog database to be updated by Apparatus 400, a transaction record of another PoS device, rules for updating shadow catalog database by Apparatus 400, thresholds for deleting items, or the like. In some exemplary embodiments, User 495 may provide user input indicating categories in a shadow catalog database, updated prices of items, or the like. Additionally or alternatively, User 495 may provide approvals for specific changes in the shadow catalog databases updated by Apparatus 400, such as for example an approval to delete an item, to reduce an items price in a reduction over a predetermined amount or proportion, or the like. Additionally or alternatively, I/O Module 405 may be used to provide translations of items names, items categories, or the like. It will be appreciated that Apparatus 400 can operate automatically without human operation.

In some exemplary embodiments, Apparatus 400 may comprise a Memory Unit 407. Memory Unit 407 may be a hard disk drive, a Flash disk, a Random Access Memory (RAM), a memory chip, or the like. In some exemplary embodiments, Memory Unit 407 may retain program code operative to cause Processor 402 to perform acts associated with any of the subcomponents of Apparatus 400.

In some exemplary embodiments, PoS Device 460 may be configured to send transaction records to Apparatus 400 via I/O Module 405. PoS Device 460 may be configured to record transactions made at the point of sale, by recording names, prices and other information of items in each transaction. I/O module 405 may be configured to receive a transaction record from PoS Device 460, in response to each transaction made by PoS Device 460, or in a batch manner periodically. Additionally or alternatively, a representative sample of transaction records may be obtained instead of all transaction records. Additionally or alternatively, the received transaction records may be redacted to remove personal or confidential information such as a name of customer. In some exemplary embodiments, a unique identifier for a customer may be retained in the redacted version without disclosing the identity of the customer while allowing identifying transactions made by the same customer.

In some exemplary embodiments, PoS Device 460 may utilize an Item Catalog Database 470. Item Catalog Database 470 may be a catalog of an organization associated with PoS Device 460. Item Catalog Database 470 may comprise items available at a PoS of the organization and their prices. It will be appreciated that Item Catalog Database 470 can be a non-electronical database.

In some exemplary embodiments, Apparatus 400 may be configured to maintain one or more shadow catalog databases, such as a Shadow Catalog Database 440, a Second Shadow Catalog Database 450, or the like.

In some exemplary embodiments, Memory Unit 407 may comprise a Transaction Record Analysis Module 410. Transaction Record Analysis Module 410 may be configured to analyze transaction records obtained in response to transactions made by PoS devices such as PoS Device 460.

In some exemplary embodiments, Transaction Record Analysis Module 410 may be configured to perform an analysis based on a plurality of transaction records made by one or more PoS devices associated with an organization, wherein the one or more PoS devices comprise the PoS Device 460. Transaction Record Analysis Module 410 may analyze transaction records stored in a Transaction Records Repository 490. In some exemplary embodiments, Transaction Records Repository 490 may be configured to store each transaction record obtained by I/O Module 405

In some exemplary embodiments, Transaction Record Analysis Module 410 may be configured to analyze entries of items in the transaction records, names of the items, prices of the items, or the like.

In some exemplary embodiments, Memory Unit 407 may comprise a Shadow Catalog Update Module 420. Shadow Catalog Update Module 420 may be configured to update Shadow Catalog Database 440, based on analysis performed by Transaction Record Analysis Module 410. In some exemplary embodiments, Shadow Catalog Update Module 420 may be configured to update several shadow catalog databases, such as Shadow Catalog Databases 440, 450.

In some exemplary embodiments, Shadow Catalog Update Module 420 may be configured to add new items and prices of the items to Shadow Catalog Database 440, based on entries of the items in transaction records. Additionally or alternatively, Shadow Catalog Update Module 420 may be configured to delete items from Shadow Catalog Database 440, update prices of items in Shadow Catalog Database 440, change the order of items in Shadow Catalog Database 440, update metadata of items in Shadow Catalog Database 440, or the like.

In some exemplary embodiments, Transaction Record Analysis Module 410 may comprise a Lookup Module 412. Lookup Module 412 may be configured to search for an item in a shadow catalog such as Shadow Catalog Database 440 or Second Shadow Catalog Database 450. In some exemplary embodiments, Lookup Module 412 may be configured to find an existing item in a catalog database that corresponds to an entry in the transaction record. Shadow Catalog Update Module 420 may utilize the output of Lookup Module 412 to update a price of the existing item in Shadow Catalog Database 440 or 450, based on a transaction price in the entry.

Additionally or alternatively, Shadow Catalog Update Module 420 may be configured to delete an existing item from Shadow Catalog Database 440 or 450, based on the existing item not appearing in a plurality of transaction records within a timeframe.

In some exemplary embodiments, Transaction Record Analysis Module 410 may comprise a Pattern of Appearance Identifying Module 414. Pattern of Appearance Identification Module (PAIM) 414 may be configured to identify a pattern of appearance of an item in a transaction based on a plurality of transaction records. In some exemplary embodiments, PAIM 414 may be configured to identify a correlation between the item and other items in the plurality of transaction records. Shadow Catalog Update Module 420 may be configured to update Shadow Catalog Database 440 or 450 based on the pattern of appearance of the item, such as, for example, based on the correlation between the item and the other items.

In some exemplary embodiments, Transaction Record Analysis Module 410 may be configured to determine, based on the correlation between the item and other items, that the item is an add-on item to a base item in the transaction record. Shadow Catalog Update Module 420 may be configured to update Shadow Catalog Database 440 or 450 to reflect that the item is an add-on item to the base item.

Additionally or alternatively, PAIM 414 may be configured to identify an expected order of items in a transaction based on the plurality of transaction records. Shadow Catalog Update Module 420 may be configured to update Shadow Catalog Database 440 or 450 based on the expected order of items.

In some exemplary embodiments, Shadow Catalog Update Module 420 may be configured to utilize a Category Determination Module 422 to determine a category for an item. In some exemplary embodiments, Category Determination Module 422 may determine that two items are of different categories based on the expected order of the two items. Shadow Catalog Update Module 420 may be configured to update Shadow Catalog Database 440 or 450 to reflect the different categories of the two items. Additionally or alternatively, Category Determination Module 422 may be configured to determine a category of an item in Shadow Catalog Database 440, based on the pattern of appearance determined by PAIM 414. In some exemplary embodiments, a category of an item may be a plurality of alternative categories and Category Determination Module 422 may exclude one alternative category at each analysis cycle until a single concrete category is deduced.

In some exemplary embodiments, Category Determination Module 422 may be configured to determine clusters of items based such that each cluster is indicative of a same category of items in the cluster. Category Determination Module 422 may be configured to determine the clusters based on the patterns of appearance of the items determined by PAIM 414. Shadow Catalog Update Module 420 may be configured to identify a cluster which comprises the item and set a category of the item in Shadow Catalog Database 440 based on the cluster.

In some exemplary embodiments, Shadow Catalog Update Module 420 may be configured to utilize a Taxonomy Identification Module 424 to determine a taxonomy of Shadow Catalog Database 440 or 450 based on the clusters of items. Shadow Catalog Update Module 420 may be configured to update Shadow Catalog Database 440 or 450 based on the taxonomy of the shadow catalog database.

In some exemplary embodiments, Shadow Catalog Update Module 420 may be configured to identify a catalog database that is similar to Shadow Catalog Database 440 or 450. Shadow Catalog Update Module 420 may be configured to utilize Taxonomy Identification Module 424 to determine a taxonomy for Shadow Catalog Database 440 or 450 based on a taxonomy of the similar catalog database.

In some exemplary embodiments, Shadow Catalog Database 450 may be provided in a language different than Shadow Catalog Database 440. Shadow Catalog Update Module 420 may utilize a Dictionary 480 to determine a translation of the name of an item existing in Shadow Catalog Database 440 or in the transaction record but not in Shadow Catalog Database 450, in the language of Shadow Catalog Database 450. Shadow Catalog Update Module 420 may be configured to add a new item to Shadow Catalog Database 450 using the translation of the name.

In some exemplary embodiments, the disclosed subject matter may be employed in a computerized environment where a direct interface does exist between a second shadow catalog database and the item catalog database. The direct interface may be specifically tailored and programmed to allow for synchronization between the two databases. In some cases, the direct interface may utilize an Application Program Interface (API), that is employed to programmatically cause an update in the item catalog database to invoke an equivalent update in the second shadow catalog.

In some cases, a shadow catalog database having no direct interface to the item catalog database, may be maintained in accordance with the disclosed subject matter. The content of which may be used to verify correctness of the direct interface between the item catalog database and the second shadow catalog database, such as may be examined during a testing phase. In some cases, integrating two systems may be a complicated task which is potentially bug-prone. By using the shadow catalog database, bugs may be easily detected based on discrepancies between the content of the shadow catalog database and the content of the second shadow catalog database. In some cases, as the shadow catalog database may be updated only after a timeframe comprising transactions has elapsed. As a result, the discrepancy analysis may be based on a state of the shadow databases prior to the timeframe, to avoid identifying a discrepancy that is caused by the slower update rate of the shadow catalog database in comparison to an immediate update that is based on a direct interface.

Additionally or alternatively, the second shadow catalog database may be useful for training a supervised machine learning module to provide better classification based on a transaction stream. In some cases, from the transaction stream, a pattern of appearance of an item may be determined and used for updating the shadow catalog database. As an example, a category of an item may be deduced by a machine learning module, based on the pattern of appearance of an item. The machine learning module may be a supervised machine learning module that is trained using a training dataset. The training dataset may comprise pairs of patterns of appearance and a category of the item, as appearing in the second shadow catalog database. Using such training dataset, the machine learning module may be trained to correctly predict the category of an item based on pattern of appearance of an item. Other forms of training sets may be created using information extracted from the second shadow catalog database to improve prediction capabilities of machine learning modules based on streams of transactions. In some exemplary embodiments, the trained machine learning module may be used for other systems, where a second shadow catalog database having a direct interface to the item catalog database is not available. In some exemplary embodiments, the trained machine learning module may be used in relation to catalogs of similar nature, such as from a same type of organization.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method performed by a computing device in a computerized environment, wherein the computerized environment comprising a purchase transaction processor utilizing an item catalog database, wherein the computing device maintaining a shadow catalog database, wherein said method comprising:
in response to a transaction made by the purchase transaction processor, obtaining, by the computing device, a transaction record, wherein the transaction record comprising for each item in the transaction, an entry, wherein the entry comprising a name of the item and a transaction price of the item, wherein the entry is based on the item catalog database; and
updating, based on the transaction record, the shadow catalog database, whereby the shadow catalog database is updated automatically based on transactions and without having a direct interface between the item catalog database and the shadow catalog database.

2. The method of claim 1, wherein said updating comprises adding an item and a price of the item to the shadow catalog database, based on an entry of the item in the transaction record.

3. The method of claim 1, further comprises:
identifying an existing item in the shadow catalog database based on an entry in the transaction record;
wherein said updating comprises updating a price of the existing item in the shadow catalog database, based on a transaction price in the entry.

4. The method of claim 1, wherein said updating is performed based on a plurality of transaction records made by one or more purchase transaction processors associated with a business entity, wherein the one or more purchase transaction processors comprise the purchase transaction processor.

5. The method of claim 4, wherein said updating comprises deleting an existing item from the shadow catalog database, based on the existing item not appearing in the plurality of transaction records.

6. The method of claim 5, wherein the plurality of transaction records are obtained in response to all transactions performed on behalf of the business entity within a timeframe.

7. The method of claim 4 further comprises:
determining a pattern of appearance of an item in a transaction based on the plurality of transaction records;
wherein said updating is performed based on the pattern of appearance of the item.

8. The method of claim 7,
wherein the pattern of appearance comprises a correlation between the item and other items;
wherein said method further comprises determining, based on the correlation, that the item is an add-on item to a base item; and
wherein said updating comprises updating the shadow catalog database to reflect that the item is an add-on item to the base item.

9. The method of claim 7, wherein the pattern of appearance comprises an expected order of items in a transaction based on the plurality of transaction records; wherein said updating is performed based on the expected order of items.

10. The method of claim 9, wherein said updating comprises determining that two items are of different categories based on the expected order of the two items; and updating the shadow catalog database to reflect the different categories of the two items.

11. The method of claim 7,
wherein the item in the shadow catalog database is represented by an entry comprising a name, a price, and category of the item, and wherein the plurality of transaction records do not comprise the category of the item; and
wherein said updating comprises determining a category of the item based on the pattern of appearance.

12. The method of claim 7, further comprising:
determining clusters of items based on the patterns of appearance of the items, such that each cluster is indicative of a same category of items in the cluster;
wherein said updating comprises:
identifying a cluster which comprises the item; and
setting a category of the item in the shadow catalog database based on the cluster.

13. The method of claim 12, further comprising:
determining a taxonomy of the shadow catalog database based on the clusters of items;
wherein said updating is performed based on the taxonomy of the shadow catalog database.

14. The method of claim 7, wherein said updating is performed based on the pattern of appearance of the item using a machine learning module, wherein the machine learning module is trained using a training dataset comprising pattern of appearances and content of a second shadow catalog database, wherein the second shadow catalog database is updated based on a direct interface to the item catalog database.

15. The method of claim 1, further comprises:
automatically identifying a catalog database that is similar to the shadow catalog database;
wherein based on a taxonomy of the catalog database, determining a taxonomy for the shadow catalog database;
wherein said updating is performed based on the taxonomy of the shadow catalog database.

16. The method of claim 1, wherein the shadow catalog database is provided in a first language, wherein a second shadow catalog database corresponding to the shadow catalog database is provided in a second language;
wherein the transaction record is provided in the first language;
wherein the method further comprising updating the second shadow catalog database based on the transaction record.

17. The method of claim 16, wherein said updating the second shadow catalog database comprises:
identifying a corresponding item in the second shadow catalog database that corresponds to an item in the transaction record; and
updating a price of the corresponding item based on the transaction price of the item in the transaction record.

18. The method of claim 16, wherein said updating the second shadow catalog database comprises:
determining an absence of a corresponding item in the second shadow catalog database that corresponds to an item in the transaction record;
utilizing a dictionary to determine a translation of the name of the item in the first language to the second language, whereby a second name of the item in the second language is determined; and
adding a new item to the second shadow catalog database using the second name.

19. The method of claim 1,
wherein the entry comprising a catalog number of the item; and
wherein said updating comprises:
performing, based on the catalog number, a lookup in the shadow catalog database for a corresponding item; and
updating the corresponding item in the shadow catalog database based on the entry of the item in the transaction record.

20. The method of claim 1, wherein a second shadow catalog database is configured to be updated based on a direct interface between the second shadow catalog database and the item catalog database, wherein said method comprising verifying the direct interface operating properly by comparing content of the second shadow catalog database with content of the shadow catalog database.

21. A computerized apparatus having a processor, the processor being adapted to perform the steps of:
in response to a transaction made by a purchase transaction processor utilizing an item catalog database, obtaining a transaction record, wherein the transaction record comprising for each item in the transaction, an entry, wherein the entry comprising a name of the item and a transaction price of the item, wherein the entry is based on the item catalog database; and
updating, based on the transaction record, a shadow catalog database, whereby the shadow catalog database is updated automatically based on transactions and without having a direct interface between the item catalog database and the shadow catalog database.

22. A computer program product comprising a non-transitory computer readable storage medium retaining program instructions, which program instructions when read by a processor, cause the processor to perform a method comprising:
in response to a transaction made by a purchase transaction processor utilizing an item catalog database, obtaining a transaction record, wherein the transaction record comprising for each item in the transaction, an entry, wherein the entry comprising a name of the item and a transaction price of the item, wherein the entry is based on the item catalog database; and
updating, based on the transaction record, a shadow catalog database, whereby the shadow catalog database is updated automatically based on transactions and without having a direct interface between the item catalog database and the shadow catalog database.
